(19) United States
(12) Patent Application Publication
(10) Pub. No.: US 2008/0304897 A1
(43) Pub. Date: Dec. 11, 2008

(54) TUBULAR APPLICATOR FOR SOLID TOILETRY PRODUCT WITH AN INNER TUBULAR MEMBER HAVING NOTCHED HELICAL GROOVES

(75) Inventor: Jerrold H. Rosenblatt, Burlingame, CA (US)

Correspondence Address: MARK YOUNG, P.A., 12086 FORT CAROLINE ROAD, UNIT 202, JACKSONVILLE, FL, 32225, US

(73) Assignee: FRENCH TRANSIT, LTD., Burlingame, CA (US)

(21) Appl. No.: 12/036,437

(22) Filed: Feb. 25, 2008

Related U.S. Application Data
(63) Continuation-in-part of application No. 11/760,265, filed on Jun. 8, 2007.

(51) Int. Cl. A45D 40/02; B43K 21/08

(52) U.S. Cl. 401/78; 401/65

(57) ABSTRACT

A natural mineral deodorant stick applicator includes a holder having at least one holder tab extending radially outwardly; an elongated outer tubular member having a longitudinal slot; an elongated inner tubular member rotatably held within the outer tubular member and having a notched helical groove. The tab of the holder is configured for projection through the helical groove and into the elongated slot. The holder is movable relative to the inner and outer tubular members as the inner tubular member is rotated relative to the outer tubular member. The notched helical groove includes a notched lower edge and a smooth upper edge. Each one of the plurality of adjacent inclined sections is set off from another adjacent inclined section by a step. The step forms a backstop which prevents the holder tab from retreating downwardly past the backstop. The step defines an increment of advancement. The holder tab is adapted to glide along the notched lower edge.

### RELATED PENDING APPLICATION

This application is a continuation in part and claims the benefit of priority of pending non-provisional patent application Ser. No. 11/760,265, filed Jun. 8, 2007, the entire contents of which are incorporated herein by this reference and made a part hereof.

### FIELD OF THE INVENTION

This invention generally relates to a container for dispensing natural mineral salt deodorant, and more particularly, to an applicator assembly having an inner tubular member with notched helical grooves to define advancement increments and prevent retreating of advanced solid product.

### BACKGROUND

Natural mineral salt deodorant is a hypoallergenic, fragrance-free, paraben-free, non-sticky, non-staining, deodorant stick that dries instantly and leaves no white residue. It can be used by both men and women. It is applied to the body, e.g., the armpits to reduce body odor caused by the bacterial breakdown of perspiration. The natural mineral salts typically include ammonium alum or potassium alum, a common type of alum available in crystal form. Such alternative deodorants, commonly known as natural mineral or rock deodorants, are gaining increasing consumer acceptance because of their long life and image as a healthy alternative to conventional antiperspirant. As natural mineral deodorant does not contain any moisture, a user must wet the deodorant with water before it is used, usually by either holding it under a running tap or immersing it in a sink filled with water. Once the deodorant is wet, the user applies the top of the deodorant to the body using considerable force. After use, the deodorant is allowed to dry.

When considerable force is applied to stick-like cosmetics and toiletries, the stick may retreat into the applicator. This problem is particularly prevalent with natural mineral deodorant, which requires considerable force during application.

Another problem is over-extension. If a stick-like cosmetic or toiletry is extended excessively it can be somewhat unstable when used, especially when a sideways force is applied. It would be preferable to define extension increments to avoid over-extension.

Furthermore, if natural mineral deodorant is held in place on a movable platform by a frictional projection inserted into the natural mineral deodorant, a central hole must be formed in the natural mineral during the manufacturing process. If this method of holding the natural mineral deodorant onto a platform is used, the deodorant can be somewhat unstable when it is extended from the tube and a sideways force is applied. Restricting the amount by which the deodorant can be extended from the tube, and thus allowing the inner circumference of the tube to stabilize the product, has the disadvantage of causing a portion of the product to be wasted, as that portion of the product must remain below the top of the container and therefore cannot be used. A longer projection, which might provide more stability, also reduces the useful life of the product, since once the projection extends from the top of the deodorant, the user is prevented from using the product as it is intended. Additional projections into the base of the deodorant require a more complicated manufacturing process as more holes in the deodorant must be provided.

What is needed is an applicator that resists retraction, defines extension increments and does not require circumferential stability or projections into the base of the stick-like substance. The invention is directed to overcoming one or more of the problems and solving one or more of the needs as set forth above.

### SUMMARY OF THE INVENTION

An object of an exemplary implementation of the invention is to provide an applicator that resists retraction.

Another object of an exemplary implementation of the invention is to provide an applicator that defines extension increments.

Yet another object of an exemplary implementation of the invention is to provide an applicator that does not require circumferential stability or projections into the base of the stick-like substance being dispensed.

To achieve one or more of the objects set forth above, and to solve one or more of the problems set forth above, in an exemplary implementation of the invention, a natural mineral deodorant stick applicator includes a dispenser with a first open end configured to dispense a mineral stick; a holder configured to hold the mineral stick in the dispenser and allow the mineral stick to extend outwardly from the first open end of the dispenser, the holder is movable relative to the dispenser, the holder having at least one holder tab extending radially outwardly; an elongated outer tubular member having a first open end and a second open end; an elongated inner tubular member, having a first open end and a second end, held within the outer tubular member such that the inner tubular member may be rotated relative to the outer tubular member and wherein the second end of the inner tubular member extends outwardly from the second end of the outer tubular member in order to provide a surface that allows the inner tubular member to be gripped and rotated relative to the outer tubular member, the inner tubular member having a notched helical groove, and the outer tubular member having an elongated slot operatively associated with the helical groove; and the tab of the holder is configured for projection through the helical groove and into the elongated slot and the holder is movable relative to the inner and outer tubular members as the inner tubular member is rotated relative to the outer tubular member. The notched helical groove includes a notched lower edge and a smooth upper edge. Each one of the plurality of adjacent inclined sections is set off from another adjacent inclined section by a step the step forms a backstop which prevents the holder tab from retreating downwardly past the backstop. The step defines an increment of advancement. The holder tab is adapted to glide along the notched lower edge.

Each inclined section may be configured to allow unrestrained advancement of the tab along each section. Alternatively, each inclined section may include a protuberance. The protuberance may be adjacent to but before a step. The protuberance provides a tactile signal.

The plurality of inclined sections and corresponding steps may be evenly or unevenly spaced. Without limitation, 1 to 20 inclined sections may be provided, with each one of the plurality of adjacent inclined sections being set off from another adjacent inclined section by a step.

In another aspect of the invention, an exemplary mineral stick applicator includes a dispenser with a first open end configured to dispense a mineral stick and a holder configured to hold the mineral stick in the dispenser and allow the mineral stick to extend outwardly from the first open end of the dispenser. The holder is movable relative to the dispenser and has at least one holder tab extending radially outwardly. An elongated outer tubular member has a first open end and a second open end. An elongated inner tubular member has a first open end and a second end held within the outer tubular member such that the inner tubular member may be rotated relative to the outer tubular member and wherein the second end of the inner tubular member extends outwardly from the second end of the outer tubular member in order to provide a surface that allows the inner tubular member to be gripped and rotated relative to the outer tubular member. The inner tubular member has a notched helical groove including one or more notches configured to prevent retreat. The outer tubular member has an elongated slot operatively associated with the helical groove. The tab of the holder is configured for projection through the helical groove and into the elongated slot and the holder is movable relative to the inner and outer tubular members as the inner tubular member is rotated relative to the outer tubular member. The notched helical groove includes a notched lower edge and a smooth upper edge. The notched lower edge includes one or more notches includes adjacent inclined sections, with each one of the adjacent inclined sections being set off from another adjacent inclined section by a step. The step forms a backstop which prevents the holder tab from retreating downwardly past the backstop. The step defines an increment of advancement. The holder tab is adapted to glide along the notched lower edge. Each inclined section is configured to allow unrestrained advancement of the tab along each section. Approximately, 1 to 20 inclined sections are included, with each one of the plurality of adjacent inclined sections being set off from another adjacent inclined section by a step. Optionally, a protuberance may be provided adjacent to but before each step to provide a tactile signal of the approaching step.

### BRIEF DESCRIPTION OF THE DRAWINGS

The foregoing and other aspects, objects, features and advantages of the invention will become better understood with reference to the following description, appended claims, and accompanying drawings, where:

FIG. 1 shows an exploded, perspective section view of an exemplary applicator assembly having an inner tubular member with notched helical grooves to define advancement increments and prevent retreating of advanced solid product according to principles of the invention; and

FIG. 2 shows a perspective section view of an exemplary inner tubular member of an applicator assembly, said inner tubular featuring notched helical grooves to define advancement increments and prevent retreating of advanced solid product according to principles of the invention; and

FIG. 3 shows a perspective section view of an exemplary outer tubular member of an applicator assembly, said outer tubular member featuring an elongated slot longitudinally disposed on its inside surface according to principles of the invention; and

FIG. 4 shows a perspective section view of an exemplary holder having tabs that for insertion through the notched helical grooves of the inner tubular member and into the elongated slot of the outer tubular member according to principles of the invention; and

FIG. 5 shows a perspective section view of a portion of an exemplary inner tubular member of an applicator assembly, said inner tubular featuring notched helical grooves to define advancement increments and prevent retreating of advanced solid product, and a holder tab extending through the notched helical groove and movable from a first pre-notch position to another post-notch position according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the types of footwear, shapes, relative sizes, ornamental aspects or proportions shown in the figures.

### DETAILED DESCRIPTION

Referring to the Figures, in which like parts are indicated with the same reference numerals, various views of an exemplary applicator assembly and components thereof according to principles of the invention are shown. The term “applicator” is used herein for convenience to refer to a device for applying any stick-like hard substance, including natural mineral deodorant.

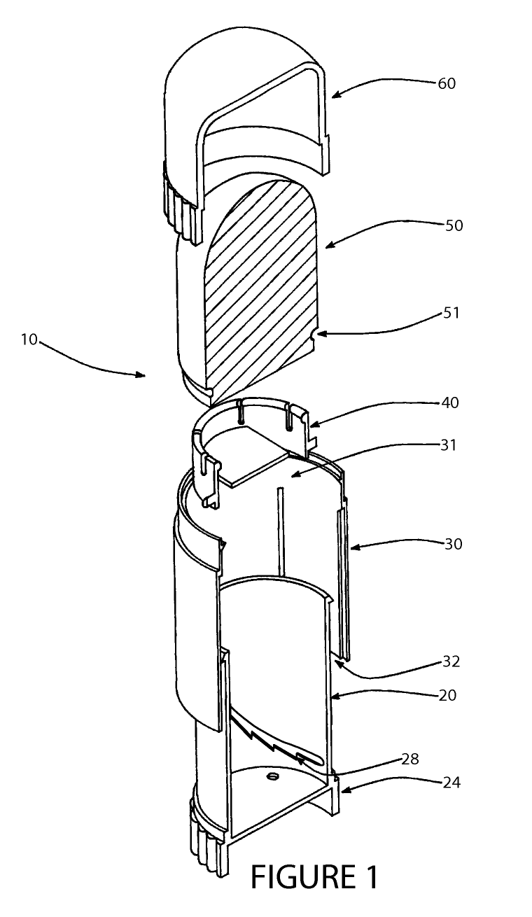

Referring to FIG. 1, an exploded, sectional view of tubular container 10 in accordance with a exemplary embodiment of the invention is shown. The tubular container 10 includes an inner tubular member 20, outer tubular member 30, a holder 40 for holding a solid substance such as crystal deodorant 50, and a lid 60.

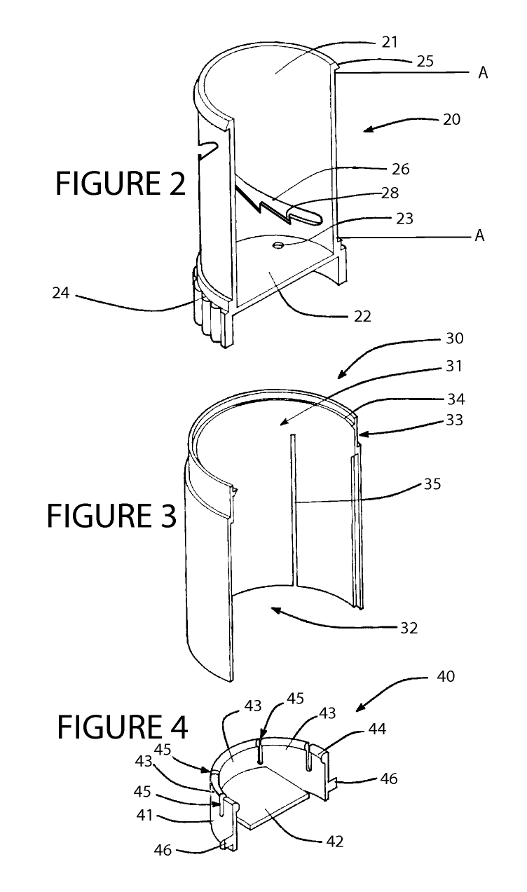

With reference to FIGS. 1 and 2, the inner tubular member 20 has at least one open end 21. The opposite end 22 of the inner tubular member may be either open or closed; however, if closed, the material blocking the tube may have, if desired, at least one hole 23 to allow water or other fluid to be channeled away from the solid crystal deodorant 50 and allow it to dry.

With reference to FIGS. 1 and 3, the outer tubular member 30 is open at both ends, 31, 32. The outside 33 of the outer tubular member near the end 31, may be of a slightly smaller external diameter than the rest of the tubular member to allow a cap 60 to fit on the end 31. Alternatively, the end 31 may be configured to accept a screw-type cap. The inside circumference of the outer tubular member near the end 31 forms a shallow shelf 34.

The inner tubular member 20 is positioned within the outer tubular member 30 such that a portion of the inner tubular member 20 extends from the end 32 of the outer tubular member 30. The exposed portion 24 of the inner tubular member 20 may have a slightly increased external diameter in comparison with the rest of the inner tubular member 20 so that it has substantially about the same external diameter as the outer tubular member 30. The exposed portion may also be fluted or otherwise textured to make it easier for the user to grasp and turn.

The outside circumference of the end 21 of the inner tubular member 20, opposite the exposed portion 24, is formed with a shallow shelf 25 that rest on and cooperates with the shelf 34 on the inner circumference of the outer tubular member 30, so that the inner tubular member may be rotated relative to the outer tubular member by grasping and turning the exposed portion 24 of the inner tubular member 20. The shelf 25 and the exposed portion 24 insure the outer tubular member 30 to be positioned and held on the inner tubular member 20.

The inner tubular member 20 has two notched helical grooves or ramps 26, although those of ordinary skill in the art will appreciate that a different number and shape of grooves might be used. In this exemplary embodiment, these notched helical grooves 26 extend completely through the wall of the inner tubular member 20. The notched helical grooves 26 are oriented such that they proceed around the circumference of the inner tubular member 20 in the same direction, clockwise or counter-clockwise, toward a particular end of the inner tubular member 20.

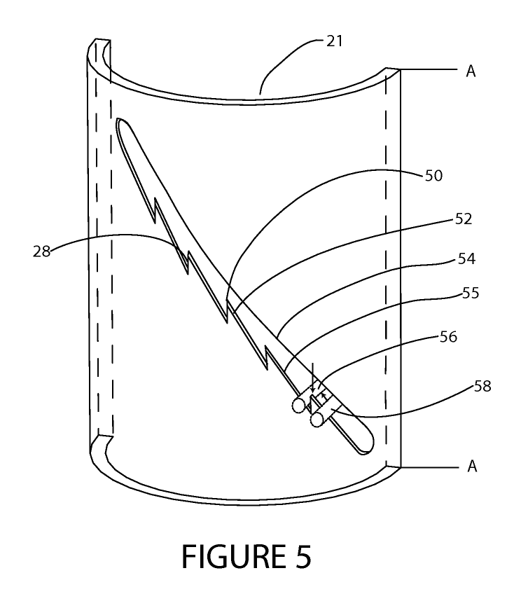

Referring now to FIG. 5, each exemplary notched helical groove 26 includes a notched lower edge 55 and a smooth upper edge 54. The lower edge comprises a plurality of adjacent inclined sections 52, with each inclined section 52 being set off from an adjacent inclined section by a steep step 50. The steep step 50 forms a backstop 28 which prevents the holder tab 56 from retreating downwardly. The step 50 also defines an increment of advancement. In use, a holder tab 46 progresses along the lower edge 55, gliding from one inclined section to a next adjacent inclined section, and being restrained from retreating (as in position 56) by the backstop 28 separating adjacent inclined sections. As force is exerted against the deodorant or other solid substance the tab 46 and backstop 28 may clash and the backstop 28 prevents further retreat. Advantageously, the inclined sections 52 of the a notched lower edge 55 of the notched helical groove 26 allow unrestrained advancement of the tab 46 along a section and from one section to the next higher section, while the backstops 28 prevent retreat of the tab 46 to a lower inclined section 52.

In an alternative embodiment, a small protuberance may be provided on each inclined section 52, adjacent to but before a step 50, to provide tactile signal of the imminent step. The protuberance may be small so as to provide a tactile indication of an approaching step 50, without substantially impeding forward progress. Thus, a user may be alerted before the mineral stick is advanced to a step 50.

The invention is not limited to any particular number or size of inclined sections and steps. In an exemplary implementation, there are sufficient steps to provide to define many discrete points of advancement. By way of example and not limitation, steps may coincide with advancement of the mineral stick in 5, 10, 20, 25 or 50% percent increments. Illustratively, 5, 10, 15, 20 or some other number of evenly spaced inclined sections and steps may be provided to define 5, 10, 15, 20 or some other number of increments of the mineral stick. Of course, unevenly spaced and unequal sized steps and increments may be utilized without departing from the scope of the invention. The invention is not limited to an particular number or arrangement of steps.

The outer tubular member 30 includes two straight slots 35 on the internal wall of the member. The notched helical grooves 26 and the straight slots 35 are positioned in their respective tubular members such that when one of the notched helical grooves 26 crosses one of the straight slots 35 at a particular distance from the end 32 of the outer tubular member 30, the other notched helical groove 26 will cross the other straight slot 35 at substantially same distance.

Referring now to FIGS. 1 and 4, the container further includes a holder 40 which is particularly suitable for holding a natural mineral deodorant 50. Although in the exemplary embodiment the natural mineral deodorant is substantially cylindrical in shape, those of skill in the art will appreciate that other geometries could be used.

The holder 40 includes an outer wall 41, which is in the shape of a short cylinder with an internal diameter approximately the same as than the external diameter of the natural mineral deodorant product 50. If the external perimeter of the natural mineral deodorant was shaped differently, the internal perimeter of the wall 41 of the holder 40 could be modified to conform to that shape. It should be noted that the external diameters of both the natural mineral deodorant and the holder are slightly smaller than the internal diameter of the inner tubular member 20 to allow the holder 40 and the natural mineral deodorant 50 to be able to move within the inner tubular member 20 and to allow fluid to flow around and away from the crystal deodorant 50.

The holder 40 also includes a floor 42 at one end. The floor 42 does not completely close the end of the holder 40. In the exemplary embodiment the floor 42 conforms to the internal perimeter of the wall 41 for only portions of that perimeter, thus forming drainage apertures or gaps along the internal perimeter of the wall 41. Other configurations of gaps or openings are possible. For example, the openings could be created by one or more circular openings, a cross-shaped floor, etc. These gaps or openings in the floor 42 allow fluid to flow out of the holder away from the natural mineral deodorant product and allow air to reach portions of the natural mineral deodorant product 50 which are supported by the floor 42. Thus, this structure limits deterioration of the natural mineral deodorant caused by constant exposure to water.

The wall 41 forms projections 43 which extend away from the floor 42. These projections 43 may be formed so that they are somewhat resilient and thus may be slightly expandable in a radial direction to allow for insertion of and a better influence on the product. The ends of the projections 43 form inwardly-facing flanges 44. There are gaps 45 between the projections 43 that are large enough to allow fluid to flow through them. This has the advantage of allowing water to flow out of the holder 40 away from the natural mineral deodorant product 50, discouraging deterioration of the natural mineral deodorant.

In use, one end of the cylindrically-shaped natural mineral deodorant product 50 is positioned in the holder 40 so that one end rests on or is near the floor 42 with the projections 43 in contact with the mineral deodorant product 50. Although not required, positioning the natural mineral deodorant product so that its entire end surface does not rest on the floor 42 may increase the ability of the gaps or openings in the floor 42 to channel water away from the product. Further, although not required, spacers (not shown) might be used to create such a gap.

The natural mineral deodorant product is formed such that it has an indentation 51 around its circumference such that when positioned within the holder the flanges 44 can engage the indentation 51 and thus hold the deodorant product 50 in place. The use of the flanges 44 to hold the deodorant product in place simplifies the overall manufacturing process since it is not necessary to form a hole or holes in the natural mineral deodorant to accept a projection as is a taught in U.S. Pat. Nos. 5,286,126 and 5,346,323. Furthermore, in the present invention the deodorant is held in a more stable position on the holder without the need for a separate stabilizing and centering structure within the cylinder such as the fingers shown in those patents.

The holder 40 further includes two tabs 46 extending radially outward from the outer circumference of the holder 40. Each tab 46 is operatively associated with a notched helical groove 26 and a slot 35. The holder 40 is positioned within the inner tubular member 20, and the inner tubular member 20 and the holder 40 are positioned relative to the outer tubular member 30 such that each tab 46 extends through a notched helical groove 26 and into a slot 35. Each tab 46 must therefore be of a sufficient length to allow both tabs 46 to engage the slots 35 in this manner. However, the tabs 46 must be short enough and of proper size to allow the holder 40 to be level within the inner tubular member 20 and to permit free movement of the tabs along the slot 35 and the notched helical groove 26.

In operation, the holder 40, the inner tubular member 20 and the outer tubular member 30 are positioned as described above. The inner and outer tubular members 20, 30 are connected such that the shallow shelf 25 rests on and rotatively cooperates with the shelf 34 on the inner circumference of the outer tubular member 30. When the user grasps and turns the exposed portion 24 of the inner tubular member 20 the tabs 46 are forced to move along the notched helical groove 26 and along the slot 35, thus moving the holder 40 longitudinally relative to the tubular members 20, 30, with the direction of movement dependent upon the orientation of the notched helical grooves 26 and the direction the inner tubular member 20 is rotated. As the holder 40 moves, the natural mineral deodorant is forced out of or into the container. The slots 35 hold the holder 40, and thus the deodorant 50, so that they do not rotate relative to the outer tubular member 30. The inclined sections 52 of the a notched lower edge 55 of the notched helical groove 26 allow unrestrained advancement of the tab 46 along a section and from one section to the next higher section, while the backstops 28 prevent retreat of the tab 46 to a lower inclined section 52.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A mineral stick applicator comprising:
a dispenser with a first open end configured to dispense a mineral stick;
a holder configured to hold the mineral stick in said dispenser and allow said mineral stick to extend outwardly from the first open end of the dispenser, said holder being movable relative to the dispenser, said holder having at least one holder tab extending radially outwardly;
an elongated outer tubular member having a first open end and a second open end;
an elongated inner tubular member, having a first open end and a second end, held within the outer tubular member such that the inner tubular member may be rotated relative to the outer tubular member and wherein the second end of the inner tubular member extends outwardly from the second end of the outer tubular member in order to provide a surface that allows the inner tubular member to be gripped and rotated relative to the outer tubular member, said inner tubular member having a notched helical groove including a plurality of notches configured to prevent retreat, and said outer tubular member having an elongated slot operatively associated with the helical groove; and
said tab of the holder being configured for projection through the helical groove and into the elongated slot and the holder being movable relative to the inner and outer tubular members as the inner tubular member is rotated relative to the outer tubular member.

2. A mineral stick applicator according to claim 1, said notched helical groove comprising a notched lower edge and a smooth upper edge.

3. A mineral stick applicator according to claim 2, said notched lower edge comprising of one or more notches comprising adjacent inclined sections, with each one of said plurality of adjacent inclined sections being set off from another adjacent inclined section by a step.

4. A mineral stick applicator according to claim 3, said step forming a backstop which prevents the holder tab from retreating downwardly past the backstop.

5. A mineral stick applicator according to claim 4, said step defining an increment of advancement.

6. A mineral stick applicator according to claim 2, said holder tab being adapted to glide along the notched lower edge.

7. A mineral stick applicator according to claim 3, each inclined section being configured to allow unrestrained advancement of the tab along each section.

8. A mineral stick applicator according to claim 3, further comprising a protuberance on each inclined section.

9. A mineral stick applicator according to claim 8, wherein said protuberance is adjacent to but before a step.

10. A mineral stick applicator according to claim 8, wherein said protuberance provides a tactile signal.

11. A mineral stick applicator according to claim 3, wherein said plurality of inclined sections and corresponding steps are evenly spaced.

12. A mineral stick applicator according to claim 3, including 1 to 20 inclined sections, with each one of said plurality of adjacent inclined sections being set off from another adjacent inclined section by a step.

13. A mineral stick applicator according to claim 3, including 1 to 20 evenly spaced inclined sections, with each one of said plurality of adjacent inclined sections being set off from another adjacent inclined section by a step.

14. A mineral stick applicator comprising:
an elongated outer tubular member having a first open end and a second open end;
a holder configured to hold the mineral stick in said elongated outer tubular member and allow said mineral stick to extend outwardly from the first open end of the elongated outer tubular member, said holder being movable relative to the elongated outer tubular member, said holder having at least one holder tab extending radially outwardly;
an elongated inner tubular member, having a first open end and a second end, held within the outer tubular member such that the inner tubular member may be rotated relative to the outer tubular member and wherein the second end of the inner tubular member extends outwardly from the second end of the outer tubular member in order to provide a surface that allows the inner tubular member to be gripped and rotated relative to the outer tubular member, said inner tubular member having a notched helical groove, and said outer tubular member having an elongated slot operatively associated with the helical groove, said notched helical groove comprising a notched lower edge and a smooth upper edge, said notched lower edge comprising a plurality of adjacent inclined sections, with each one of said plurality of adjacent inclined sections being set off from another adjacent inclined section by a step, said step forming a backstop which prevents the holder tab from retreating downwardly past the backstop and defining an increment of advancement; and
said tab of the holder being configured for projection through the helical groove and into the elongated slot and the holder being movable relative to the inner and outer tubular members as the inner tubular member is rotated relative to the outer tubular member, and said tab of the holder being adapted to glide along the notched lower edge.

15. A mineral stick applicator according to claim 14, further comprising a protuberance on each inclined section.

16. A mineral stick applicator according to claim 15, wherein said protuberance is adjacent to but before a step.

17. A mineral stick applicator according to claim 16, wherein said protuberance provides a tactile signal.

18. A mineral stick applicator according to claim 14, wherein said plurality of inclined sections and corresponding steps are evenly spaced.

19. A mineral stick applicator according to claim 14, including 1 to 20 inclined sections, with each one of said plurality of adjacent inclined sections being set off from another adjacent inclined section by a step.

20. A mineral stick applicator according to claim 14, including 1 to 20 evenly spaced inclined sections, with each one of said plurality of adjacent inclined sections being set off from another adjacent inclined section by a step.
